(19) United States
(12) Patent Application Publication
(10) Pub. No.: US 2016/0143425 A1
(43) Pub. Date: May 26, 2016

(54) Parallel Webbing Attachment System

(71) Applicant: John Tvrdy, Stow, MA (US)

(72) Inventor: John Tvrdy, Stow, MA (US)

(21) Appl. No.: 14/950,870

(22) Filed: Nov. 24, 2015

Related U.S. Application Data
(60) Provisional application No. 62/083,487, filed on Nov. 24, 2014.

(51) Int. Cl. A45F 5/02; F16B 2/22

(52) U.S. Cl. CPC A45F 5/02; F16B 2/22; A45F 2005/025

(57) ABSTRACT

An attachment system for removable attachment of articles to segments of parallel fabric webbing, including parallel webbing on MOLLE/PALS-compatible equipment. The attachment system includes a first clip and a second clip which may be fixedly or rotatably attached to each other via a fastener. The first clip has a first center portion, a first wing forming a first open loop, and a first leg extending therefrom. The second clip has a second center portion, a second wing forming a second open loop, and a second leg extending therefrom.

### CROSS REFERENCE TO RELATED APPLICATIONS

This application claims the benefit of U.S. Provisional Application No. 62/083,487 filed on Nov. 24, 2014. The above identified patent application is herein incorporated by reference in its entirety to provide continuity of disclosure.

### BACKGROUND OF THE INVENTION

The present invention generally relates to attachment systems for securing articles to a garment or bag. More particularly, the present invention relates to an attachment system for mounting articles on garments or bags having a parallel webbing grid such as MOLLE/PALS-compatible equipment.

Military servicemen, law enforcement personnel, and other individuals often carry large amounts of specially designed gear in order to perform their respective duties. Because of constantly changing conditions in the field, it is desirable for such individuals to be able to quickly reconfigure pouches, pockets, holsters, and other gear attachment mechanisms. The interchangeable nature of an attachment mechanism is desirable because it allows a single garment, bag, or the like to be adaptable to meet certain needs depending on mission parameters or field conditions.

One type of adaptable attachment mechanism commonly used is known as PALS, which is an acronym for “Pouch Attachment Ladder System.” PALS utilizes parallel webbing sewn onto load bearing equipment such as a bag, a vest, or other garments. The parallel webbing consists of horizontal rows of fabric attached to the load-bearing equipment at identically-spaced intervals, forming a patchwork of attachment points. The most common type of load bearing equipment utilizing PALS is known as MOLLE, which is an acronym for “Modular Lightweight Load-carrying Equipment.” The use of the PALS webbing system allows for the attachment of a large variety of MOLLE-compatible accessories such as pouches, holsters, and the like.

One drawback of the MOLLE system is that it is difficult to attach articles to MOLLE equipment that are not compatible with MOLLE or PALS. One may need such articles but lack the means to attach them in the same secure manner as MOLLE-compatible articles. For example, one may have difficulty attaching articles having vertical loop attachment mechanism to the PALS webbing, which utilizes horizontal loops for fastening articles. Even if the article is able to be attached, the article may have to be rotated in order to align the loops of the MOLLE system and the article for proper attachment. This potentially hinders user access to the article, which can be undesirable as users may need to quickly access an attached article for a particular purpose. It is therefore desirable to provide an attachment mechanism adapted to secure articles having a vertical loop attachment mechanism to MOLLE and PALS-compatible equipment.

### SUMMARY OF THE INVENTION

In view of the foregoing disadvantages inherent in the known types of attachment systems now present in the prior art, the present invention provides an attachment system wherein the same can be utilized for providing convenience for the user when securing articles to MOLLE and PALS compatible equipment. The present attachment system comprises a first clip having a first center portion with proximal and distal ends, a first wing extending from the proximal end of the first center portion, and a first leg extending from the first wing, the first leg extending toward the distal end of the first center portion, and a second clip having a second center portion with proximal and distal ends, a second wing extending from the proximal end of the second center portion, and a second leg extending from the second wing, the second leg extending toward the distal end of the second center portion, wherein the first clip and the second clip are attached to one another at an attachment point.

One object of the present invention is to provide an attachment system having all the advantages of the prior art but none of the disadvantages.

Another object of the present invention is to provide an attachment system having a first and second clip rotatably attached to one another for changing the orientation of articles secured thereto.

A further object of the present invention is to provide an attachment system that allows users to quickly reconfigure the orientation of articles attached to MOLLE/PALS equipment.

Still another object of the present invention is to provide a method of attaching an article to a segment of parallel webbing, the method including the steps of attaching a first clip of an attachment system to a segment of parallel webbing, rotating a second clip that is rotatably attached to the first clip a determined amount of degrees to a desired position, and attaching an article to the second clip.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side perspective view of an attachment system according to the present invention.

FIG. 1B shows a side perspective view of an attachment system according to the present invention in a rotated position.

FIG. 2A shows a top-down view of an attachment system according to the present invention.

FIG. 2B shows a top-down view of an attachment mechanism according to the present invention in a rotated position.

FIG. 3A shows a side exploded view of an attachment system according to the present invention.

FIG. 3B shows a perspective exploded view of an attachment system according to the present invention.

FIG. 4 shows a detail view of an attachment system according to the present invention attached to a segment of parallel webbing.

FIG. 5 shows a perspective view of an attachment system according to the present invention in a rotated position attached to a segment of parallel webbing.

### DETAILED DESCRIPTION OF THE INVENTION

Reference is made herein to the attached drawings. Like reference numerals are used throughout the drawings to depict like or similar elements of the attachment mechanism. For the purposes of presenting a brief and clear description of the present invention, the preferred embodiment will be discussed as used for a parallel webbing attachment system. The figures are intended for representative purposes only and should not be considered to be limiting in any respect.

As used herein, the terms “MOLLE” and “PALS” refers to any item utilizing corresponding rows of parallel webbing for allowing modular article attachment. Further, the terms “MOLLE” and “PALS” are not to be construed as limiting the with respect to the present invention. As such, the terms “MOLLE” and “PALS” broadly includes any and all systems that utilize spaced attachment points for modular article attachment.

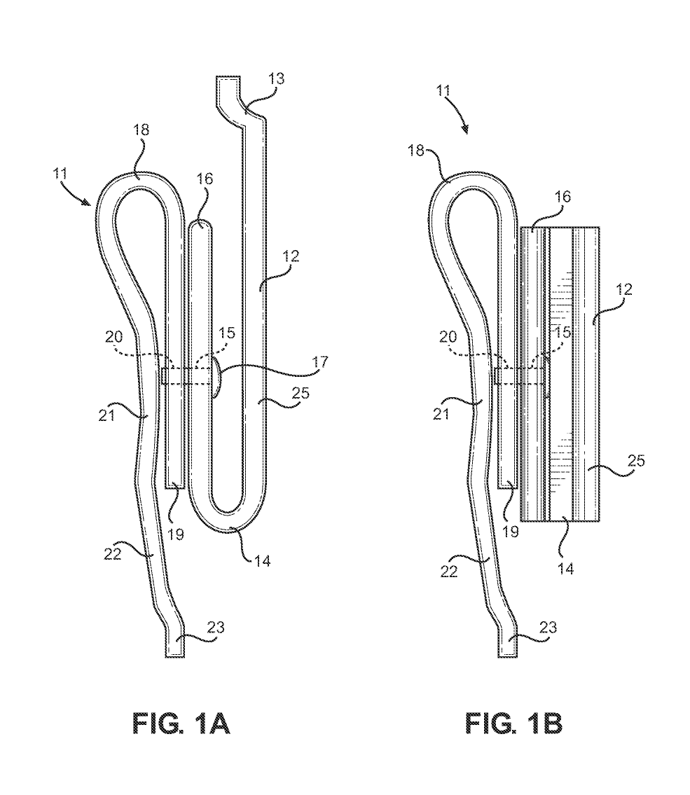

Referring now to FIGS. 1A and 1B, there are shown side views of an attachment system according to the present invention. The attachment system 11 generally comprises a first clip 12 and a second clip 21 oppositely attached to one another. The first clip 12 comprises a first center portion 16 having proximal and distal ends. A first wing 14 extends from the proximal end of the first center portion 16. A first leg 25 extends from the first wing 14 in a parallel alignment with the first center portion 16 and in the same direction thereof. The first center portion 16, first wing 14, and first leg 25 are structured such that the wing 14 forms an open loop.

In some embodiments, the first leg 25 is spring biased towards the first center portion 16 in order to secure a section of fabric or a portion of an article therebetween during use. The first leg 25 additionally comprises a first projection 13 that extends toward the first center portion 16 of the first clip 12. The first projection 13 provides additional securement for articles inserted between the first leg 25 and the first center portion 16. In the illustrated embodiment, the first center portion 16 comprises a first attachment point 15, which comprises an aperture configured to receive a fastener for connecting the first clip 12 and second clip 21.

The second clip 21 comprises a second center portion 19 having proximal and distal ends, a second wing 18 extending from the distal end of the second center portion 19, and a second leg 22 extending from the second wing 18. The second wing 18 forms an open loop between the second center portion 19 and the second leg 22.

In some embodiments, the second leg 22 is spring biased towards the second center portion 19 in order to secure a section of fabric or a portion of an article therebetween during use. The second leg 22 additionally comprises a second projection 23 that extends toward the second center portion 19 of the second clip 21. The second projection 23 provides additional securement for articles inserted between the second leg 22 and the second center portion 19.

In the illustrated embodiment, the second center portion 19 comprises a second attachment point 20, which is an aperture configured to receive a fastener for connecting the first clip 12 and second clip 21, similar to the first attachment point 15. Each of the first attachment point 15 and second attachment point 20 receive a portion of a fastener 17, which is configured to secure the first clip 12 and the second clip 21 to one another. The fastener 17 may be a rivet, nut and bolt, or the like.

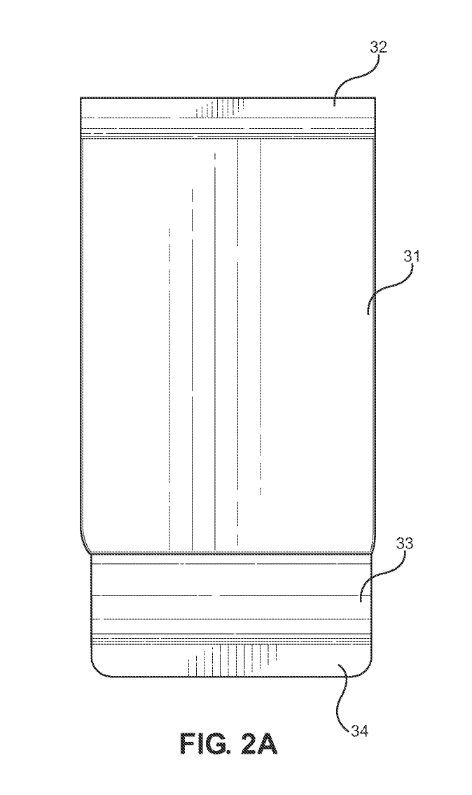

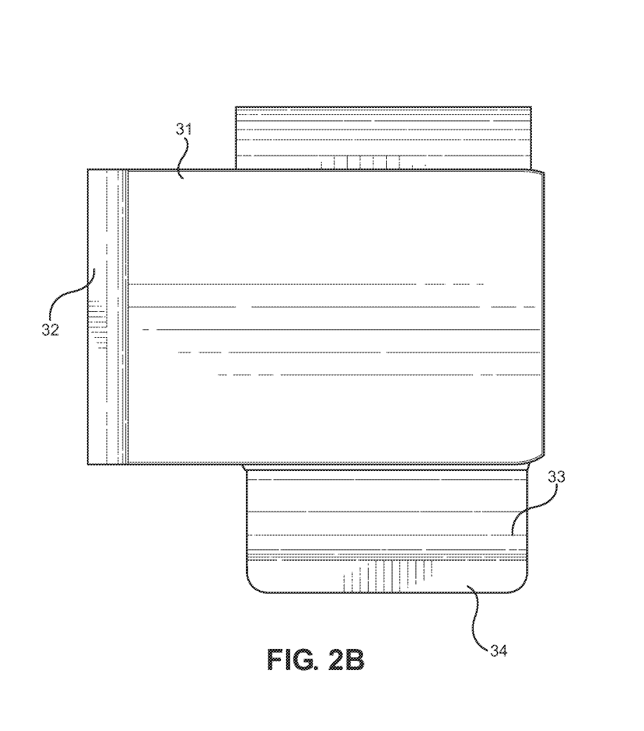

Referring now to FIGS. 2A and 2B, there are shown top-down views of an attachment system according to the present invention. In one embodiment of the invention, the first clip 31 and the second clip 33 are fixedly attached perpendicular to one another, in the orientation shown in FIG. 2B. The first clip 31 and second clip 33 may also be rotatably attached to one so that the orientation shown in FIG. 2A may be utilized, for example, to attach articles having a vertical loop of fabric to a portion of horizontal parallel webbing.

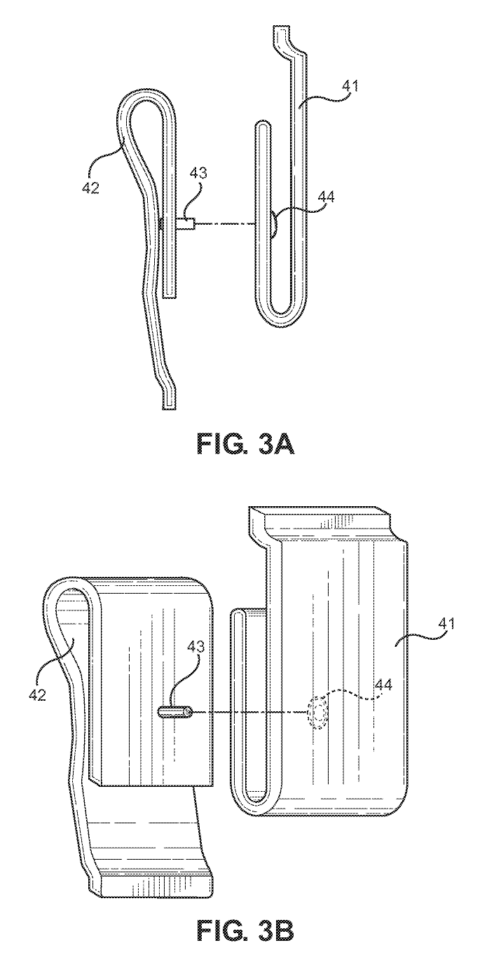

Referring now to FIGS. 3A and 3B, there are shown exploded views of an attachment system according to the present invention. In an alternative embodiment, the first clip 41 and the second clip 42 are rotatably attached to one another via a fastener. In the illustrated embodiment, the fastener comprises a post 43 that is received by a connector 44, such that the post 43 is rotatable about the connector 44. The connector 44 includes an interior channel that has a diameter within close tolerance of the diameter of the post 43 so that they frictionally engage when the post is inserted therein.

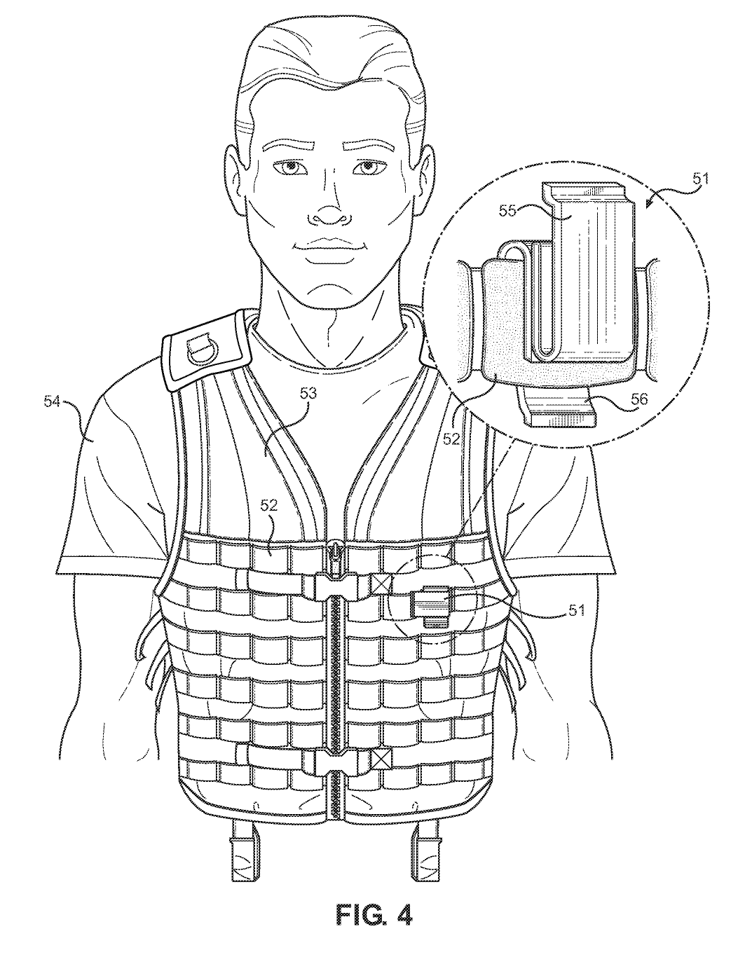

Referring now to FIG. 4, a perspective view of an attachment system according to the present invention attached to a segment of parallel webbing is shown. The present invention is envisioned to be utilized by an individual 54 wearing a bag or article of clothing such as a vest 53 having segments of parallel webbing 52 disposed thereon. The attachment system 51 is attached to a horizontal portion of fabric such as a section of parallel webbing 52. The section of parallel webbing 52 receives the first clip 56 and supports the attachment system thereon 51. Alternatively, the section of parallel webbing 52 may receive the second clip 55. The first clip 56 and the second clip 55 are interchangeable so that either clip may be used for attaching the attachment mechanism 51 to MOLLE or PALS equipment.

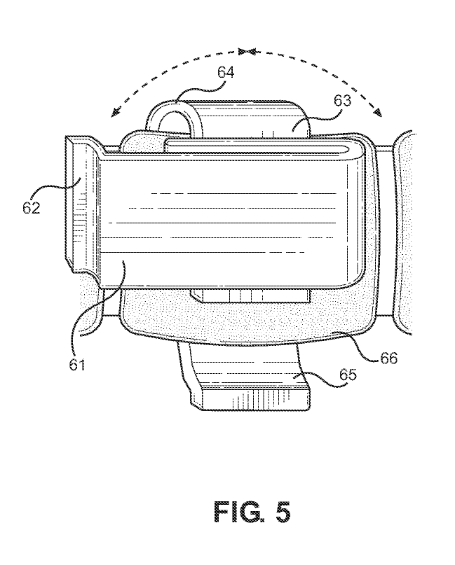

Referring now to FIG. 5, a close-up view of an attachment system according to the present invention attached to a MOLLE-compatible item is shown. The illustrated embodiment shows an attachment system 63 according to the present invention wherein the first clip 61 is rotatably attached to the second clip 65. The second clip 65 is attached to a MOLLE-compatible garment or bag, whereby the second wing 64 of engages with an upper edge section parallel webbing 66.

In order to utilize the present invention for attaching articles having a vertical loop to MOLLE systems, a user first attaches the attachment system 63 to a MOLLE item by engaging the section of parallel webbing 66 with the open loop portion formed by the second wing 64. The user then may rotate the first clip 61 to the requisite position, which is determined by the desired orientation of the attached article. Once the first clip 61 is rotated to the required position, a user may then attach an item having a vertical loop to the first clip 61. The first projection 62 extends toward the section of parallel webbing 66 and provides additional securement for articles secured thereto, prevent articles from accidentally disconnecting from the section of parallel webbing 66.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An attachment system comprising:
a first clip comprising a first center portion having a proximal end and a distal end, a first wing extending from the proximal end of the first center portion, and a first leg extending from the first wing, the first leg extending toward the distal end of the first center portion;
a second clip comprising a second center portion having a proximal end and a distal end, a second wing extending from the proximal end of the second center portion, and a second leg extending from the second wing, the second leg extending toward the distal end of the second center portion; and
wherein the first clip and the second clip are attached to one another at an attachment point.

2) The attachment system of claim 1, wherein the first center portion and the second center portion each comprise an aperture, wherein each aperture is configured to receive a portion of a fastener therethrough.

3) The attachment system of claim 1, wherein the first clip and the second clip are fixedly attached perpendicular to one another at the attachment point.

4) The attachment system of claim 2, wherein the first clip and the second clip are rotatably attached to one another at the attachment point via the fastener.

5) The attachment system of claim 1, wherein the attachment system is compatible with MOLLE systems.

6) The attachment system of claim 1, wherein the attachment system is compatible with PALS systems.

7) The attachment system of claim 1, wherein the first clip and the second clip are each configured to releasably engage with a fabric webbing.

8) The attachment system of claim 4, wherein the second leg of the second clip further comprise a projection, the projection extending outward from the second center portion of the second clip.

9) The attachment system of claim 1, wherein the first leg is spring biased toward the first center portion of the first clip.

10) The attachment system of claim 1, wherein the second leg is spring biased toward the second center portion of the second clip.

11) The attachment system of claim 1, wherein the first clip further comprises a shoulder extending from the first leg, the shoulder comprising a projection extending toward the first center portion of the first leg.

12) The attachment system of claim 1, wherein the first clip further comprises a shoulder extending from the first leg, the shoulder comprising a projection extending toward the first center portion of the first leg.
